(19) United States
(12) Patent Application Publication
(10) Pub. No.: US 2018/0264934 A1
(43) Pub. Date: Sep. 20, 2018

(54) LIQUID TANK WITH A PLASTIC SHELL

(71) Applicant: Veritas AG, Gelnhausen (DE)

(72) Inventors: Thomas Rösch, Linsengericht (DE); Wilfried Moh, Muhlhausen (DE)

(21) Appl. No.: 15/917,379

(22) Filed: Mar. 9, 2018

(30) Foreign Application Priority Data
Mar. 14, 2017 (DE) 10 2017 105 395.6

(51) Int. Cl. B60K 13/04; B29C 45/14; F01N 3/20; B60K 15/03

(52) U.S. Cl. CPC B60K 13/04; F01N 2530/18; F01N 3/2073; B60K 15/03006; B60K 15/03177; B60K 2015/03493; B60K 2015/03427; B60K 2015/03039; B60K 2015/03046; F01N 2610/10; F01N 2610/02; F01N 2610/1486; B60K 2015/03348; F01N 2240/16; F01N 2610/1406; F01N 2530/06; B29C 45/14

(57) ABSTRACT

The present disclosure relates to a fluid tank for storing fluid for use in a motor vehicle. The fluid tank may include a fluid tank shell that defines a chamber of the fluid tank; a heating device in the chamber of the fluid tank and configured to heat the fluid in the fluid tank; and a plastic jacket that encloses at least a portion of the heating device.

### CROSS-REFERENCE TO RELATED APPLICATIONS

This application claims priority to German patent application No. 10 2017 105 395.6. entitled “FLüSSIGKEITSTANK MIT EINER KUNSTSTOFFHÜLLE”, and filed on Mar. 14, 2017 by the Applicant of this application. The entire disclosure of the German application is incorporated herein by reference for all purposes.

### BACKGROUND

The present disclosure relates to a fluid tank with a plastic jacket for use in a motor vehicle. More specifically, the present disclosure relates to a urea tank for storing an aqueous urea solution and comprising a heating device and a plastic jacket for use in a motor vehicle.

To reduce the emission of nitrogen oxides during the operation of an internal combustion engine, in particular, a diesel engine, in a motor vehicle, the method of selective catalytic reduction (SCR) is used, wherein an aqueous urea solution is fed into the exhaust gas system of the motor vehicle. The urea solution to be provided can be stored in a fluid tank. Because the freezing point of the urea solution used is approximately −11° C., it is necessary, during periods of low outdoor temperatures, to heat the urea solution in the fluid tank in order to prevent the urea solution from freezing. To this end, to heat the urea solution, heating devices can be positioned inside the fluid tank. However, that installation of heating devices inside the chamber of the fluid tank is limited by the geometry of the fluid tank and by the mounting options and by the fact the heating device can he damaged by the urea solution in the fluid tank.

The printed document DE 8 615 526 U1 describes a plastic fuel tank for motor vehicles. The fuel tank comprises two half-shells, each one of which forms an upper half-shell and, on the bottom of the fuel tank, a lower half-shell. However, the fuel tank does not include a heating device for heating the fuel tank. The problem to be solved by the present disclosure is to make available a fluid tank comprising a heating device that is suitably disposed on the fluid tank.

### SUMMARY

This problem is solved by the subject matter of the disclosure having the features of the independent claim. Useful examples of the disclosure arc disclosed by means of the figures, the description, and the dependent claims.

According to one aspect of the disclosure, the problem is solved by a fluid tank for storing a fluid in a motor vehicle, comprising a fluid tank shell that defines an interior chamber of the fluid tank, a heating device that is disposed inside the chamber of the fluid tank and that serves to heat the fluid in the fluid tank, and a plastic jacket that encloses at least portions of the heating device.

The fluid tank is specifically designed as a urea tank for storing an aqueous urea solution and, in particular, comprises a tank for storing an additive or an SCR tank.

The heating device disposed in the fluid tank offers the technical advantage that the fluid tank shell, and thereby the fluid contained in the fluid tank, can be effectively heated. The plastic jacket disposed inside the chamber of the plastic tank surrounds at least portions of the heating device and thereby protects the heating device from the fluid, in particular, from the urea solution in the fluid tank. The heating device can be suitably disposed inside the chamber of the fluid tank to ensure an effective supply of heat to the fluid so as to protect the fluid from freezing and/or to thaw a coating of ice on the surface of the fluid and thereby to make it possible for the fluid tank to be effectively vented.

Because the heating device is disposed inside the chamber of the heating device [sic; fluid tank], the electrical lines for supplying electrical energy to the heating device need not be routed through the fluid tank shell, thereby creating a fluid tank shell that is extremely impermeable to fluid. Furthermore, the size and the heat output of the heating device as well as the respective size of the plastic jacket can be adapted to suitably conform to the geometry of the fluid tank.
In a useful example of the disclosure, the fluid tank shell and the plastic jacket are formed of a plastic material, with the plastic jacket being fusion-bonded, specifically welded, to the fluid tank shell.

The resulting technical advantage thereof is, for example, that an especially effective and stable attachment of the plastic jacket to the fluid tank shell is ensured so that the plastic jacket effectively secures the heating device to the fluid tank shell.

In another useful example of the disclosure, the plastic jacket is integrally formed in one piece together with the fluid tank shell.

The resulting technical advantage thereof is, for example, that because of the single-piece design, the fluid tank shell and the plastic jacket can be produced as one common [sic; as a single] structural component. The shape of the plastic jacket simply needs to be designed to conform to the shape of the heating device, and the heating device can subsequently be installed in the fluid tank and be effectively surrounded by the plastic jacket.

In yet another useful example of the disclosure, the heating device has an outside wall, in particular an outside wall formed of metal, which is connected to the plastic jacket so as to be force-fitted, form-fitting, and/or fusion-bonded.

The resulting technical advantage thereof is, for example, that the heating device can be effectively installed in the plastic jacket, and that, because of the force-fitted, form-fitting, and/or fusion-bonded connection between the heating device and the plastic jacket, the heating device is effectively held in place inside the plastic jacket. More specifically, the plastic jacket can be sprayed onto the outside wall of the heating device, thereby ensuring that the heating device is effectively surrounded by the plastic jacket.

In yet another useful example of the disclosure, a plurality of ribs is disposed on the outside wall, which ribs bound a plurality of grooves on the outside wall, with the ribs and grooves providing an effective connection between the outside wall and the plastic jacket.

The resulting technical advantage thereof is, for example, that the ribs and grooves ensure that the plastic jacket can be effectively applied to the outside wall. To this end, fluid plastic can flow along the outside wall through the grooves that bound the ribs and can be uniformly distributed on the outside wall and subsequently can expediently cool down so as to form a homogeneous plastic jacket.

In yet another useful example of the disclosure, an inside wall of the fluid tank shell facing the chamber of the fluid tank has an accommodating contour designed to accommodate the heating device, with the accommodating contour being configured specifically in the form of a depression or a cavity in the inside wall.

The resulting technical advantage thereof is, for example, that the accommodating contour on the inside wall of the fluid tank ensures that the heating device is especially effectively affixed to the inside wall of the fluid tank shell. To this end, the accommodating contour can he configured, for example, in the form of a depression or a cavity, the geometry of which can be conveniently adapted to conform to the shape of the heating device so as to effectively accommodate the heating device in the accommodating contour.

In yet another useful example of the disclosure, the heating device can be snapped or pressed into the accommodating contour so that, by snapping or pressing the heating device into the accommodating contour, a force-fitted and/or form-fitting connection between the heating device and the accommodating contour is formed.

The resulting technical advantage thereof, for example, consists of an especially stable and gap-free transition between the heating device and the fluid tank shell can be obtained, thereby ensuring an effective heat transfer. To this end, while the heating device is being installed, the accommodating contour can initially bend elastically, and subsequently the heating device can be snapped or pressed into the accommodating contour, thereby causing a force-fitted and/or form-fitting connection between the heating device and the accommodating contour.

In yet another useful example of the disclosure, the heating device comprises an electrical heating element, for heating the heating device, with the electrical heating element comprising, in particular, an electrical resistive heating element, a positive temperature coefficient (PTC) device, and/or a PTC film.

The resulting technical advantage thereof is, for example, that an electrical heating element provides an effective heat input so that the heating device can heat the fluid in the fluid tank. An electrical resistive heating element provides an effective source of heat. A PTC device can implement [sic; can be implemented as] an especially compact electrical heating element and comprise, for example, a plastic casing. A PTC film can implement [sic; can be implemented as] an electrical heating element that can be conveniently adapted to conform to the inside contour of the heating device and can therefore be conveniently installed in the heating device.

In yet another useful example of the disclosure, the heating device has an interior chamber that serves to accommodate the electrical heating element, with the electrical heating element being installed through an opening of the heating device into the interior chamber of the heating device so as to position the electrical heating element in the heating device, with the opening of the heating device connecting, in particular, the outside surface of the fluid tank to the interior chamber of the heating device, which opening of the heating device can be closed by a heating device closing element, and with at least one insulating element being disposed specifically at the opening of the heating device and/or on the closing element of the heating device.

The resulting technical advantage thereof is, for example, that the electrical heating element can be especially conveniently installed through the opening of the heating device into the interior chamber of the heating device and be positioned in the interior chamber of the heating device. To this end, the opening of the heating device specifically breaches the shell of the fluid tank and thereby connects the outside surface of the fluid tank with the interior chamber of the heating device so that the heating element can be installed from the outside through the opening of the heating device into the interior chamber of the heating device. After the electrical heating element has been installed, the opening of the heating device is closed by means of a heating device closing element, for example, a lid, in particular, [it is] closed so as to be impermeable to fluids, thereby ensuring that the interior chamber of the heating device is effectively protected from outside environmental influences, e.g., fluid. An insulating element, such as a heat-insulating element, or a plurality of insulating elements can be positioned in the interior chamber of the heating device at the opening of the heating device and/or on the closing element of the heating device in order to prevent an uncontrolled discharge of heat at the opening of the heating device.

In yet another useful example of the disclosure, the heating device comprises a spring element that serves to actuate the electrical heating element using force so as to press the electrical heating element against an outside wall of the heating device.

The resulting technical advantage thereof is, for example, that the spring element expediently presses the electrical heating element against the outside wall of the heating device in such a way that it is not possible for air gaps to form between the electrical heating element and the outside wall of the heating device, which air gaps could impair the effective discharge of heat by the heating device.

In yet another useful example of the disclosure, the heating device comprises at least one heat-conducting element for creating a heat-conducting connection between the electrical heating element and an outside wall of the heating device, with the heat-conducting element comprising, in particular, a heat-conducting sheet metal or a heat-conducting film.

The resulting technical advantage thereof is, for example, that at least one heat-conducting element ensures the effective transfer of heat from the electrical healing element to the outside wall. For example, at least one heat-conducting sheet metal can be a beat-conducting sheet metal formed of brass, copper, or aluminum that is disposed on the electrical heating element and that is designed to effectively absorb the heat discharged by the electrical heating element and thereby dissipate it especially effectively from the electrical heating element. For example, one or a plurality of heat-conducting films can be disposed between the electrical heating element and the outside wall or between one or a plurality of heat-conducting sheet metals and/or the outside wall. At least one heat-conducting film ensures an effective transfer of heat from the electrical heating element through the heating device to the outside wall. To this end, the heating device can, in particular, have a sandwich structure in which a plurality of heat-conducting sheet metals and/or a plurality of heat-conducting films is disposed between the electrical heating element and the outside wall in order to effectively conduct heat by means of the heating device.

In yet another useful example of the disclosure, the heating device comprises a heat-conducting medium that is disposed between the electrical heating element and the heat-conducting element in order to establish a heat-conducting connection between the electrical heating element and the outside wall of the heating device, with the heat-conducting medium being, in particular, a heat-conducting film, a heat-conducting fluid, or a heat-conducting paste.

The resulting technical advantage thereof is, for example, that the heat-conducting medium ensures an especially effective and compact heat-conducting arrangement within the heating device. Because the heat-conducting medium comprises, in particular, a heat-conducting fluid or heat-conducting paste, the heat-conducting medium is able to fill non-heat-conducting gaps between the electrical heating element and the outside wall and thereby ensure an especially effective transfer of heat within the heating device. To this end, the heat-conducting medium can be disposed, in particular, between different or a plurality of different layers in the heating device, e.g., between the electrical heating element, one or a plurality of heat-conducting elements, such as heat-conducting sheet metals or beat-conducting films, and/or the outside wall.

In yet another useful example of the disclosure, the fluid tank comprises a pump module for pumping fluid out of the fluid tank, with the pump module disposed inside the chamber of the fluid tank and the pump modules comprising an additional heating device for heating the pump module and/or the fluid tank shell.

The resulting technical advantage thereof is, for example, that the additional heating device ensures effective heating of the pump module so that the pump module can effectively and efficiently pump fluid out of the fluid tank, without the risk of ice interfering with the pumping procedure. The additional heating device is, in particular, integrally configured in one piece with the pump module. In particular, the pump module is connected to the fluid tank shell and the additional heating device is connected to the fluid tank shell as well.

In yet another useful example of the disclosure, the heating device is configured in the form of a plate or a cylinder, in particular one having rounded-off edges, with the plate being configured, in particular, as an acoustic baffle [sic; anti-slosh baffle] for inhibiting the movement of fluid in the fluid tank.

The resulting technical advantage thereof is, for example, that a plate or a cylinder has a suitable geometrical shape such that it can be effectively accommodated inside the chamber of the fluid tank, and that during operation, a correspondingly shaped heating device can effectively discharge heat to the fluid. If the heating device has the shape of a plate, the plate can be installed disposed inside the chamber of the fluid tank in such a way that the plate inhibits the sloshing movement of the fluid in the fluid tank, in which case it may be possible to omit additional anti-slosh-baffles.

In yet another useful example of the disclosure, the fluid tank shell is formed by a lower half-shell of the fluid tank and an upper half-shell of the fluid tank, with the heating device disposed on an inside wall of the upper half-shell of the fluid tank facing the inside chamber of the fluid tank.

The resulting technical advantage thereof is, for example, that, when ice forms in the fluid tank, a heating device disposed on the upper fluid tank shell breaks through [sic; thaws] the ices coating, thereby effectively creating a venting path through the ice cover.

In yet another useful example of the disclosure, the outside wall of the heating device entails a first thickness, and the plastic jacket entails a second thickness, with the second thickness being lower than thee first thickness.

The resulting technical advantage thereof is, for example, that the lower thickness of the plastic jacket ensures an especially effective dissipation of heat from the heating device to the fluid in the fluid tank.

### DESCRIPTION OF THE DRAWINGS

Examples of the present disclosure are illustrated in the drawings and will be described in greater detail below.

FIG. 1 shows a diagrammatic view of a fluid tank with a cylinder-shaped heating device according to the first example;

FIG. 2 shows a diagrammatic view of a fluid tank with a plate-shaped heating device according to the second example;

FIG. 3 shows a diagrammatic view of a cross-section through a cylinder-shaped heating device according to the first example;

FIG. 4 shows a diagrammatic view of a cross-section through another cylinder-shaped heating device according to the first example; and

FIG. 5 shows a diagrammatic view of a cross-section through a plate-shaped heating device according to the second example.

### DETAILED DESCRIPTION

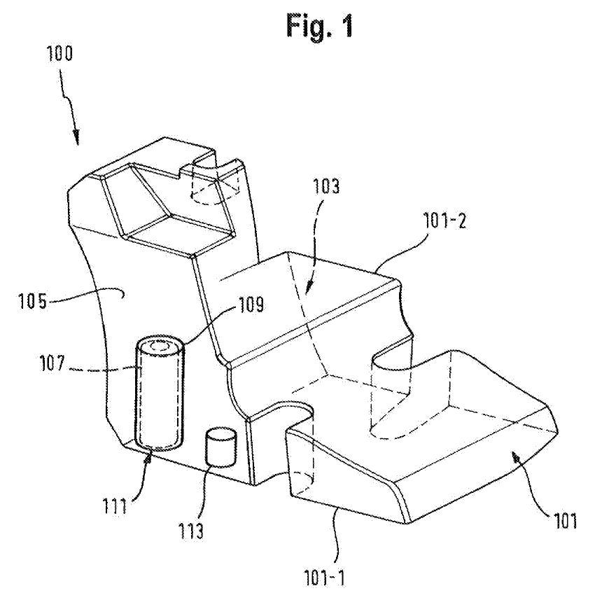

FIG. 1 shows a diagrammatic view of a fluid tank with a cylinder-shaped heating device according to the first example. The fluid tank 100 is designed, in particular, as a urea, tank for storing an aqueous urea solution. To reduce the emission of nitrogen oxides during the operation of an internal combustion engine, specifically a diesel engine, in a motor vehicle, the method of selective catalytic reduction (SCR) is used, in which a urea solution is fed into the exhaust gas system of the motor vehicle. To this end, the urea solution to be provided can be stored in the fluid tank 100. Because the freezing point of the urea solution used is approximately −11° C., it is necessary, during periods of low outdoor temperatures, to heat the urea solution in the fluid tank 100 in order to prevent the urea solution from freezing.

The fluid tank 100 shown in FIG. 1 comprises a fluid tank shell 101 that defines the chamber 103 inside the fluid tank 100, with the fluid shell 101 having an inside wall 105 facing the chamber 103. The fluid tank shell 101 is formed, in particular, of a plastic material and is, for example, a molded plastic part that is produced by means of injection molding. The plastic materials can include, for example, polyolefins, such as polyethylene or polypropylene, polyamide, and/or polyoxymethylene (POM), in particular high-density polyethylene (HDPE).

Disposed inside the chamber 103 of the fluid tank 100 is a heating device 107 that is designed to heat the fluid, in particular an aqueous urea solution, stored in the fluid tank 100. To this end, the heating device 107 is connected to the fluid tank shell 101, in particular, to the inside wall 105 of the fluid tank shell 101, in particular, by means of a fusion-bonded, form-fitting, and/or force-fitted connection. The heating device 107 shown in FIG. 1 is configured in the form a cylinder that, in particular, has rounded-off edges and that is vertically positioned inside the chamber 103 of the fluid tank 100. To this end, the heating device 107 can be disposed on the lower half-shell 101-1 of the fluid tank and/or on the upper half-shell 101-2 of the fluid tank.

The fluid tank 100 comprises, in particular, a plastic jacket 109 that encloses at least portions of the heating device 107. The plastic materials include, for example, polyolefins, such as polyethylene or polypropylene, polyamide, and/or polyoxymethylene (POM), in particular, high-density polyethylene (HDPE). The plastic material of the plastic jacket 109 can be identical to the plastic material of the fluid tank shell 101. The plastic jacket 109 can be fusion-bonded, in particular welded, to the plastic shell 101 of the fluid tank, in particular to the inside wall 105 of the fluid tank shell 101. This creates a connecting bridge 111 between the plastic jacket 109 and the fluid tank shell 101. To this end, the plastic jacket 109 can, in particular, be integrally formed in one piece with the fluid tank shell 101. Thus, the plastic jacket 109 ensures that the heating device 107 is especially effectively affixed to the fluid tank shell 101.

The inside wall 105 can also comprise an accommodating contour (not shown in FIG. 1) for accommodating the heating device 107, with the accommodating contour being configured especially in the form of an indentation or a cavity in the inside wall 105. To this end, the heating device 107 can, in particular, be snapped into the accommodating contour, so as to establish a force-fitted connection between the heating device 107 and the accommodating contour. As an alternative, the heating device 107 can, in particular, be fitted so as to conform to the accommodating contour, thereby creating a form-fitting connection between the heating device 107 and the accommodating contour.

Due to the fact that the heating device 107 is disposed inside the chamber 103 of the fluid tank 100, it can be ensured that the fluid, in particular the aqueous urea solution, is effectively heated in the fluid tank 100. To this end, the size and the heat output of the heating device 107 can he adapted to the space restrictions of the fluid tank and to the heat output required. Securing the heating device 107 to the inside wall 105 ensures that the fluid tank shell 101 is conveniently impermeable to fluid and that there is no need for electrical lines to supply the heating device 107 with electrical energy to he passed through the fluid tank shell 101.

Disposed inside the chamber 103 of the fluid tank 100 is an optional additional heating device 113 that is disposed on a pump module (not shown in FIG. 1). The additional heating, device 113 is designed to heat the pump module and/or the fluid tank shell 101 in order to prevent the aqueous urea solution in the pump module from freezing. However, if the heat output of the heating device 107 is sufficient to effectively melt the urea in the fluid tank 100, it may be possible to omit the optional additional heating device 113.

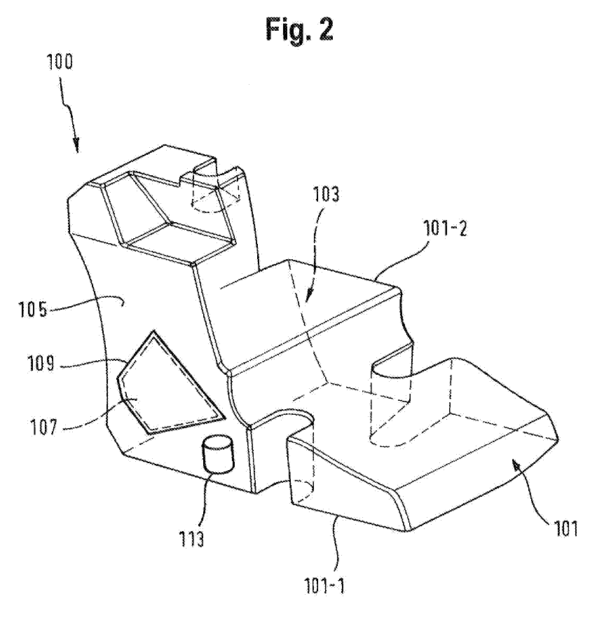

FIG. 2 shows a diagrammatic view of a fluid tank with a plate-shaped heating device according to the second example. The fluid tank 100 according to the second example as shown in FIG. 2 corresponds to the fluid tank 100 according to the first example as shown in FIG. 1, except that the heating device 107 shown FIG. 2 is not a cylinder, but a plate with rounded-off edges. A heating device 107 in the shape of a plate can be conveniently adapted to conform to a contour of the inside wall 105 of the fluid tank 100. The heating device 107 in the shape of a plate can also serve as an anti-slosh baffle that projects from the inside wall 105 into the chamber 103 of the fluid tank 100 and that is designed to inhibit the movement of the fluid in the fluid tank 100.

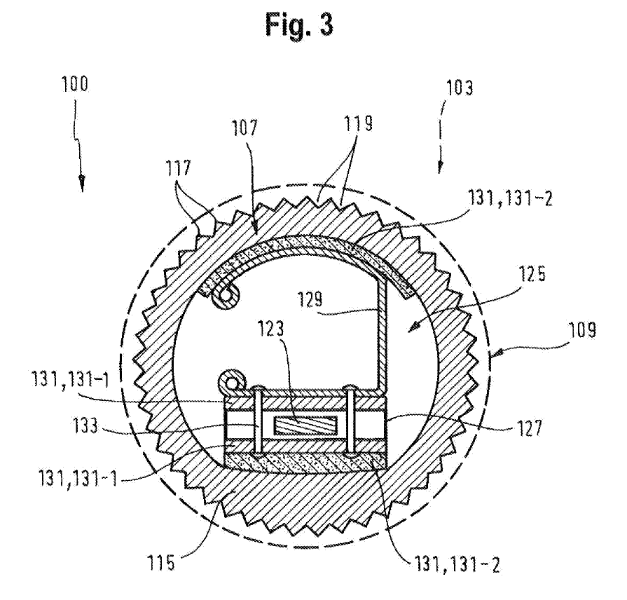

FIG. 3 shows a diagrammatic view of a cross-section through a cylinder-shaped heating device according to the first example. The heating device 107 according to the first example shown in FIG. 1 has the shape of a cylinder with rounded-off edges, the cross-sect on of which cylinder has a round shape. The heating device 107 comprises an outside wall 115 that consists, in particular, of aluminum and that is produced, in particular, by means of a continuous casting or extrusion molding process. Disposed on the outside wall 115 is a plurality of ribs 117 that defines a plurality of grooves 119. The grooves 119 are disposed between the ribs 117 on the outside wall 115. The grooves 110 are specifically designed to facilitate application of a plastic jacket 109 (only schematically shown in FIG. 3) to the outside metal wall 115. When hot plastic melt is applied to the outside wall 115, the plastic melt can conveniently flow through the grooves 119 before the plastic melt cools down and subsequently can effectively form the plastic jacket 109.

Disposed in the heating device 107 is an electrical heating element 123 that is designed to heat the heating device 107. To this end, the electrical heating element 123 can be installed through an opening of the heating device (not shown in FIG. 3) into an interior chamber 125 of the heating device that is defined by the outside wall 115. More specifically, the electrical heating element 123 can be installed from an outside surface section of the fluid tank 100 into the interior chamber 125 of the heating device. The opening of the heating device can be closed by means of a heating device closing element (not shown in FIG. 3), with at least one insulating element being disposed especially at the opening of the heating device and/or on the closing element of the heating device so as to ensure effective heat insulation.

The electrical heating, element 123 is here configured as a PTC (positive temperature coefficient) device that is disposed in a casing 127, in particular a plastic easing. The heating device 107 comprises a spring element 129 that is configured, in particular, in the form of a plastic or metal spring and that serves to actuate the electrical heating element 123 with force so as to press the electrical heating element 123 against the outside wall 115 of the heating device 107.

Thus, the spring element 129 ensures that it is not possible for air gaps to remain between the electrical heating element 123 and the outside wall 115 of the heating device 107, which air gaps could impair the transfer of heat from the electrical heating element 123 to the outside wall 115.

Disposed in the heating device 107 are heat-conducting elements 131 that serve to provide a heat-conducting connection between the electrical heating element 123 and the outside wall 115. The heat-conducting elements 131 can comprise heat-conducting sheet metals 131-1, in particular those formed of brass, copper, or aluminum, that serve to effectively discharge heat from the electrical heating element 123, especially from the plastic casing 127 of the electrical heating element 123. In addition, the heat-conducting elements 131 can also comprise heat-conducting films 131-2 designed to effectively transfer heat to the outside wall 115.

To this end, the spring element 129 presses the electrical heating element 123 together with the heat-conducting elements 131 against the outside wall 115 of the heating device 107 and thereby facilitates an effective transfer of heat between the heating elements 123 and the outside wall 115.

To affix the spring element 129 and the heat-conducting elements 131 to the inside of the heating device 107, fastening, elements 133, specifically rivets, can be used.

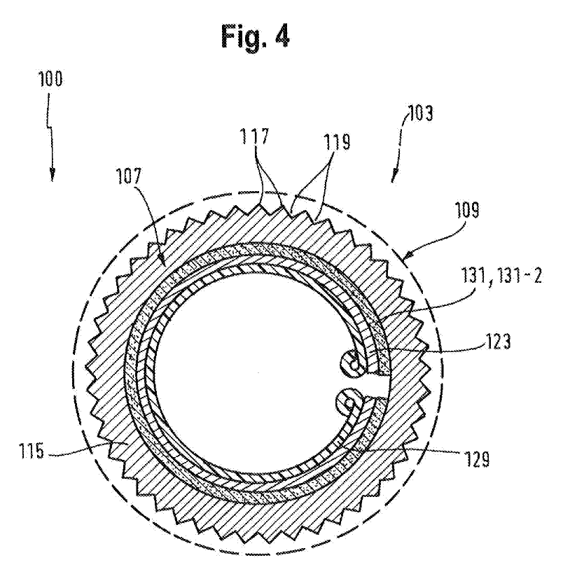

FIG. 4 shows a diagrammatic view of a cross-section through another cylinder-shaped heating device according to the first example. The shape of the heating device 107 corresponds to that of the first example shown in FIG. 1 and is configured in the form of a cylinder with rounded-off edges, the cross-section of which has a round shape. An outside wall 115 of the heating device 107 comprises a plurality of ribs 117 that defines a plurality of grooves 119, with a plastic jacket 109 being only diagrammatically defined in FIG. 4.

Disposed in the heating device 107 is an electrical heating element 123 that can be installed in the heating device 107 as shown in the practical example of FIG. 3.

The electrical heating element 123 is here configured as a PTC (positive temperature coefficient) film. The heating device 107 comprises a spring element 129 that is, in particular, configured as a plastic or metal spring and that serves to actuate the electrical heating element 123 with force so as to press the electrical heating element 123 against the outside wall 115 of the heating device 107.

Thus, the spring element 129 ensures that it is not possible for air gaps to remain between the electrical heating element 123 and the outside wall 115 of the heating device 107, which air gaps could impair the transfer of heat from the electrical heating element 123 to the outside wall 115.

Disposed in the heating device 107 are heat-conducting elements 131 that are designed to provide a heat-conducting connection between the electrical heating element 123 and the outside wall 115. The heat-conducting element 131 shown in FIG. 4 comprises a heat-conducting film 131-2 that serves to effectively transfer heat to the outside wall 115.

To this end, the spring element 129 presses the electrical heating element 123 together with the heat-conducting film 131-2 against the outside wall 115 of the heating device 107 and thereby facilitates an effective transfer of heat between the electrical heating element 123 and the outside wall 115.

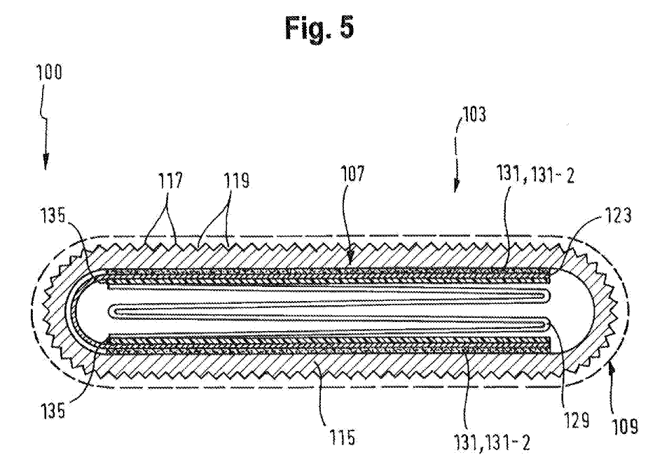

FIG. 5 shows a diagrammatic view of a cross-section through a plate-shaped heating device according to the second example. The heating device 107 according to the second example shown in FIG. 2 is configured in the form of a plate with rounded-off edges, the cross-section of which plate has an approximately rectangular shape. The heating device 107 comprises an outside wall 115 on which a plurality of ribs 117, which defines a plurality of grooves 119, is disposed. A plastic jacket 109 that is connected to the outside wall 115 is only diagrammatically defined in FIG. 5.

Disposed the heating device 107 is an electrical heating element 123 that serves to heat the heating device 107 and that, according to the practical example shown in FIG. 3, can be installed in the heating device 107.

The electrical heating element 123 is here configured in the form of a PTC (positive temperature coefficient) film. The heating device 107 comprises a spring element 129 that is configured, in particular, as a plastic or metal spring and that serves to actuate the electrical heating element 123 with force so as to press the electrical heating element 123 against the outside wall 115 of the heating device 107.

Thus, the spring element 129 ensures that it is not possible for air gaps to remain between the electrical heating element 123 and the outside wall 115 of the heating device 107, which air gaps could impair the transfer of heal from the electrical heating element 123 to the outside wall 115.

Disposed in the heating device 107 are heat-conducting elements 131 that serve to establish a heat-conducting connection between the electrical heating element 123 and the outside wall 115. The heat-conducting elements 131 can comprise heat-conducting films 131-2 that serve to effectively transfer heat to the outside wall 115.

Disposed between the spring element 129 and the electrical heating elements 123 each is a protective plate 135 made of a plastic material, which serves to protect the respective electrical heating element 123 from mechanical damage.

To this end, the spring element 129 presses the electrical heating element 123 together with the heat-conducting elements 131 and the protective plates 135 against the outside wall 115 of the heating device 107 and thereby provides an effective transfer of heat between the heating elements 123 and the outside wall 115.

All features discussed and shown in the individual examples of the disclosure can be used in different combinations to implement the subject matter according to the disclosure so as to simultaneously take advantage of their advantageous effects.

The protective scope of the present disclosure is defined by the claims and is not limited to the features discussed in the description or illustrated in the figures.

### LIST OF REFERENCE NUMBERS

100 Fluid tank
101 Fluid tank shell
101-1 Lower half-slid] of the fluid tank
101-2 Upper half shell of the fluid tank
103 Chamber of the fluid tank
105 Inside wall of the fluid tank shell
107 Heating device
109 Plastic jacket
111 Connecting bridge
113 Additional heating device
115 Outside wall
117 Rib
119 Groove
123 Electrical heating element
125 Inside chamber of the heating device
127 Casing
129 Spring element
131 Heat-conducting element
131-1 Heat-conducting sheet metal
131-2 Heat-conducting tilt
133 Fastening element
135 Protective plate

What is claimed is:

1. A fluid tank for storing fluid for use in a motor vehicle, comprising:
a fluid tank shell that defines a chamber of he fluid tank;
a heating device disposed inside the chamber of the fluid tank and configured to heat the fluid in the fluid tank; and
a plastic jacket that encloses at least a portion of the heating device.

2. The fluid tank according to claim 1, wherein the fluid tank shell and the plastic jacket are constructed of a plastic material and wherein the plastic jacket is fusion-bonded to the fluid tank shell.

3. The fluid tank according to claim 1, wherein the plastic jacket is integrally formed in one piece together with the fluid tank shell.

4. The fluid tank according to claim 1, wherein the heating device comprises an outside wall connected to the plastic jacket.

5. The fluid tank according to claim 4, wherein a plurality of ribs are disposed on the outside wall, wherein the plurality of ribs define a plurality of grooves on the outside wall, with the ribs and grooves establishing a connection between the outside wall and the plastic jacket.

6. The fluid tank according to claim 1, wherein an inside wall of the fluid tank shell facing the inside chamber of the fluid tank comprises an accommodating contour configured to accommodate the heating device, and the accommodating contour further configured as an indentation or as a cavity in the inside wall.

7. The fluid tank according to claim 6, wherein the heating device is configured to be snapped or pressed into the accommodating contour to form a force-fitted and/or form-fitting connection between the heating device and the accommodating contour.

8. The fluid tank according to claim 1, wherein the heating device comprises an electrical heating element for heating the heating device, the electrical heating element comprising an electrical resistive heating element, a positive temperature coefficient (PTC) device, or a PTC film,

9. The fluid tank according to claim 8, wherein the heating device comprises an interior chamber of the heating device configured to accommodate the electrical heating clement, the electrical heating element installed through a heating device opening of the heating device in the inside chamber of the heating device such that the electrical heating element is positioned in the heating device, and wherein the heating device opening connects art outside surface of the fluid tank to the inside chamber of the heating device, wherein the opening in the heating device is configured to be closed by a closing element on the heating device, and at least one insulating element disposed at the opening of the heating device, on the closing element of the heating device, or a combination thereof.

10. The fluid tank according to claim 8, wherein the heating device comprises a spring element configured to actuate the electrical heating element with a force such that the electrical heating element is pressed against an outside wall of the heating device.

11. The fluid tank according to claim 8, wherein the heating device comprises at least one heat-conducting element configured to create a heat-conducting connection between the electrical heating clement and an outside wall of the heating device, wherein the heat-conducting element comprises a heat-conducting sheet metal or a heat-conducting film.

12. The fluid tank according to claim 11, wherein the heating device comprises, a heat-conducting medium disposed between the electrical heating element and the heat conducting element and configured to establish a heat-conducting connection between the electrical heating element and the outside wall of the heating device, wherein the heat-conducting medium comprises a heat-conducting film, a heat-conducting fluid, or a heat-conducting paste.

13. The fluid tank according to claim 1, wherein the fluid tank comprises a pump module configured to pump fluid out of the fluid tank, wherein the pump module is disposed inside the chamber of the fluid tank and the pump module comprises an additional heating device configured to heat the pump module the fluid tank shell, or a combination thereof.

14. The fluid tank according to claim 1, wherein the heating device is configured in the form of a plate or a cylinder, and the plate configured as an acoustic plate configured to inhibit the movement of fluid in the fluid tank.

15. The fluid tank according to claim 1, wherein the fluid tank shell is formed by a lower half shell of the fluid tank and an upper half-shell of the fluid tank, and wherein the heating device is disposed on an inside wall of the upper half-shell of the fluid tank, wherein the inside wall faces the chamber of the fluid tank.

16. The fluid tank according to claim 2, wherein the plastic jacket is welded to the fluid tank shell.

17. The fluid tank according to claim 4, wherein the outside wall is an outside, metal wall.

18. The fluid tank according to claim 4, wherein the outside wall is fusion-bonded to the plastic jacket.

19. The fluid tank according to claim 14, wherein the heating device is further configured with rounded-off edges.

20. The fluid tank according to claim 14, wherein the plate configured as the acoustic plate is an anti-slosh baffle.
